(19) United States
(12) Patent Application Publication
(10) Pub. No.: US 2003/0076488 A1
(43) Pub. Date: Apr. 24, 2003

(54) Device and method for detecting flying objects

(76) Inventor: Jorg Arnold, Heidelberg (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/182,406

(22) PCT Filed: Jan. 29, 2001
(86) PCT No.: PCT/DE01/00340

(30) Foreign Application Priority Data
Jan. 27, 2000 (DE) 100 03 576.0

(51) Int. Cl. G01C 1/00; G01C 21/24

(52) U.S. Cl. 356/152.1; 250/203.1

(57) ABSTRACT

A device and a method for detecting flying objects in a predeterminable spatial area with a detector responding to the flying object for detecting the flying object are configured with respect to a reliable and largely discreet detection of the flying objects in such a manner that at least three detectors coupled in the way of a network are distributed in the spatial area, and that the detectors operate in a passive manner.

The invention relates to both a device and a method for detecting flying objects in a predeterminable spatial area with a detector responding to the flying object for detecting it.

Both a device for detecting flying objects and a method of the initially described kind are known from practice. Both the known device and the known method are used on the one hand in the civil sector, and on the other hand in the military sector. Flying objects stand for all types of objects moving above ground, such as, for example, aircrafts, rockets, or ballistic bodies. The known device includes a detector that is responsive to the flying object for detecting it. In most cases, the detector is a radar device, which emits radio signals and detects radio signals that are reflected by the flying object. In this connection, it is possible to detect position and movement of flying objects. From these data, a central computer coupled with the radar device determines moving time characteristics.

Radar devices are used, for example, in the military sector as air reconnaissance or air defense units. In this case, the radar device is named target detecting and target tracking radar unit, and the central computer simultaneously constitutes a fire control computer, and is able to control in addition a rocket battery or anti-aircraft battery for use against the flying object.

The known devices have the advantage that they enable in most cases a reliable detection of flying objects, since the radar emission in use has a great range, and remains largely unaffected by atmospheric influences, such as, for example, fog, rain, or snow. In comparison therewith, the known devices have a great disadvantage, inasmuch as they have an active character by sending out a detection beam in the form of a radar emission. This active character results in that the flying object under observation is quasi illuminated by the radar beam. In this process, the device quasi gives itself away to the flying object that is to be detected. In other words, the incident radar beam often enables the flying object to sense and spatially detect the device for detecting flying objects. In the case of a military use, this permits combating the device for detecting flying objects, which then offers itself as the target of an attack. If the flying object is now successful in destroying the device transmitting the radar beam, it will generally be no longer possible to detect additional flying objects. Furthermore, the known devices for detecting flying objects are extremely costly, since they necessitate a device for transmitting the radar beam.

It is therefore an object of the present invention to describe both a device and a method for detecting flying objects, which enable a reliable and largely discreet detection of flying objects.

In accordance with the invention, the foregoing object of providing a device for detecting flying objects is accomplished by a device for detecting flying objects with the characterizing features of claim 1. Accordingly, the known device is configured such that at least three detectors coupled in the way of a network are distributed over the spatial area, and that the detectors function in a passive manner.

To begin with, it has been recognized in accordance with the invention that—contrary to the devices for detecting flying objects so far used in the art, which operate by the principle of transmitting a detection beam—the foregoing object is achieved in a surprisingly simple manner by passively operating detectors. Detectors of this type do not transmit any detection beam, which can be used by the flying object that is to be detected for purposes of detecting in turn the device itself. Moreover, the device of the invention includes at least three detectors, which are coupled in the way of a network and distributed over the spatial area. The coupling of the detectors makes it possible to detect flying objects in a very reliable manner, since each detector has available not only the data received by itself, but also the data of other detectors. This enables a very reliable position finding of the detected flying object. Even when any of the detectors—whichever it may be—is detected and destroyed, additional detectors will be present, which can maintain the operability of the device to the greatest extent possible. Furthermore, in the case of a lost detector, the economic damage will be less than in the case of the known device, since the detectors of the present invention do not include expensive devices for transmitting a detection beam.

Consequently, the device for detecting flying objects in accordance with the invention, enables a reliable and largely discreet detection.

Concretely, the detectors could be detectors that operate optically, preferably in the infrared range. In this connection, the detector could include a photosensitive, photoelectric, photomagneto-electric, pyroelectric, or any other light-sensitive sensor. Especially suited are sensors, which make use of infrared windows of the atmosphere, since they are more independent of the influence of fog, rain, or snow than in other wavelength ranges. In this connection, the infrared window at a wavelength of 10 μm is especially advantageous, since this window permits detecting the natural body radiation or heat radiation of flying objects. This heat radiation at 10 μm is little scattered and little absorbed because of the great wavelength.

As an alternative or in addition to optically operating detectors, the device could also include acoustically or electromagnetically operating detectors. In this case, it is possible to focus on the particular case of use.

Besides the mere detection of flying objects, the detectors could also be designed for measuring the flying objects. In this instance, it will then be possible to draw conclusions as to the type of flying object.

Furthermore, it would be possible to design the detectors for tracking the flying object. Such a design will be especially advantageous in the military sector, when it is intended to combat the flying object after detecting it. Concretely, the detectors could be designed for computing the trajectory of the flying object.

In a particularly advantageous realization, it would be possible to process the data gathered by the detectors in a totally decentralized manner. In this instance, no costly, singular central computers are needed, which will make the entire device for detecting flying object inoperable in the case of damage or loss. Instead, the reliable detection of flying objects is possible within the scope of each individual detector, which also processes data of other detectors coupled therewith, but is not dependent on the data of all other detectors. In this respect, the entire device will nonetheless remain operable, when an individual detector is lost.

For a reliable processing of data in each individual detector, a processor for processing data is allocated to each detector.

Furthermore, with respect to a particularly reliable detection of flying objects, it would be possible to allocate to each detector a position finder and/or locator. This enables the detector to find its own geographic position, for example, via GPS signals, and to perform thereby a quasi absolute position finding of the detected flying object. A locating unit will take into account that instance, in which the detector is not oriented in a suitable manner, for example, relative to the earth's surface. In the case that there is an unwanted tilting of the detector, for example, relative to the earth's surface, the locating unit will be able to recognize such a faulty positioning, and preferably correct it as well. This would make it possible to compensate, for example, also an unwanted rotation of the detector, for example, relative to the north direction. To find the position, it also possible to use other radio signals besides the aforesaid GPS signals. In this connection, it would be possible to use, for example, a system as described in the International Patent Application PCT/DE97/01317. Within the scope of the locating unit, it would be possible to use a pendulum unit or a bubble level.

As regards a reliable transmission of data among the detectors, it would be possible to allocate a telecommunication unit to each detector. With that, all detectors could form with their telecommunication units a telecommunication network, which allows in principle to interconnect each detector with any detector, and to spread information of individual detectors via the telecommunication network, and “route” it in particular and purposefully to certain detectors or to certain interfaces to other system units. A usable telecommunication system of this type could be the so-called self-routing, decentralized Moteran system, and the automatic “routing process” can occur, for example, as disclosed in the above-referenced International Patent Application. It would be possible to use as interfaces, for example, connection equipment to air defense systems.

The data transmission could occur via radio signals and/or optical and/or acoustical signals. To this end, it would be possible to couple the detectors, if necessary, via electric cables and/or fiberglass cables. Likewise, the data transmission to any interfaces could occur via electric cables and/or fiberglass cables by means of radio signals and/or optical and/or acoustical signals.

As regards a reliable, independent operating mode of each individual detector, an energy supply unit could be allocated to each detector. It would be possible to use as an energy supply unit all applicable energy sources, for example, primary or secondary electrochemical cells, radionuclide cells, or fuel cells. Furthermore, it would be possible to operate the sensor as an alternative or in addition via solar cells, which are operated by the day-night storage method.

In a particularly advantageous configuration, each detector could be arranged in a spherical housing. This allows realizing a particularly robust configuration, which largely avoids an unwanted entanglement with underbrush or other plants, when used in the field.

Concretely, the detectors could be allocated to the earth's surface, which can in this instance be used as a reference system.

In a particularly simple manner, the detectors could be stochastically distributed over the earth's surface. The distribution could occur preferably by dropping or deployment from an aircraft. The altitude of the airdrop or deployment could be predeterminable depending on the case of application. The drop altitude also permits influencing the distribution of the detectors and, thus, the size of the surface, over which the detectors are spread.

As regards a protection against damage of the detectors, for example, when dropping them from an aircraft, each detector could include a device for decelerating a free fall. Such a device could include, for example, a brake fan, which fully surrounds the detector, decelerates the free fall, cushions the impact on the ground, and which could have, in a very advantageous configuration, a position-stabilizing effect on the ground. Furthermore, the device could protect against sinking into soft surroundings, such as, for example, slush, grass, underbrush, snow, or the like.

Concretely, a diaphragm rotating about a sensor could be allocated to each sensor. Depending on the position of the diaphragm, it would thus be possible to explore a predeterminable solid angle range for flying objects. As an alternative or in addition, it would be possible to allocate to each detector an annular, linear sensor arrangement or a planar or spherical sensor arrangement. A linear sensor arrangement could be formed, for example, by a hoop-shaped sensor array.

As regards a particular efficient operation, the sensor or sensors, or a radiation shield of the sensor or sensors could be thermoelectrically cooled, cooled by the Peltier effect, or cooled in a bath of liquid nitrogen, or cooled in a gas expansion via the Joule-Thompson effect. When realizing such a measure, it will be necessary to focus on the respective case of application.

As regards a method of detecting flying bodies, the foregoing object is accomplished by the characterizing steps of claim 22. Accordingly, the method is characterized in that at least three detectors, which are coupled in the way of a network, are distributed over the spatial area, and that the detectors function in a passive manner.

Concretely, the method of the invention could permit a decentralized processing of the data collected by the detectors. To this end, a processor for processing data could be allocated to each detector.

In a particularly advantageous development of the method, the processor of each detector could determine and extrapolate from the accumulated data of the detectors, preferably constantly, the time-dependent paths of motion of the detected flying object or objects.

For a better understanding of the invention, a preferred embodiment of a device for detecting flying bodies is described below in greater detail. The device is a passive system, which is set up by a larger number of distributed components—the detectors—and not from few, sensitive central components. The device is used to recognize and determine the flight movement of a flying object in an advantageous manner by more than two optical or acoustical or electromagnetic detectors. The computation of the flight path occurs by a distributed computation from the data of the individual detectors in respective processing units, which are allocated to each detector.

The embodiment represents a passive system, which enables a decentralized and automatic detection of flying objects. Within the scope of the embodiment, the device comprises 1,000 or more detectors, which are spatially or stochastically distributed over a certain field surface. Together with the average spacing between the detectors, the ultimately open number of detectors in use leads to a possible expansion of the detector field. A technically realistic average spacing between the detectors is about 1,000 m. With that, it is possible to cover with about 1,000 detectors an area of 30 km by 30 km, which is to be monitored for flight movements.

The detectors essentially consist of the actual optical detector, a position finding unit with a locating unit, a data processor, a telecommunication unit, and an energy supply unit, which are all arranged in a common, spherical housing.

The optical detector is constructed such that it is able to scan the sky with an orientation in a certain geographic direction, by the azimuthal method with a certain angular resolution. The term “azimuthal” is to indicate that the detection can occur at an angle with the direction of the normal to the earth's surface. The plane, in which the geometric direction and the azimuth arc extend, is named azimuth plane. The normal to the azimuth plane can form any desired angle between 0 and 90° with the normal to the earth's surface.

Scanning can occur via a diaphragm rotating about an individual, photosensitive sensor, or via a stationary, for example, hoop-shaped, linear sensor array, with the axis of rotation of the diaphragm or the hoop axis being oriented parallel to the surface normal of the azimuth plane. In the alternative, scanning can occur via a planar or spherical sensor array, with the surface normal extending at a certain angle from 0 to 90° to the surface normal of the earth's surface plane. When the detectors are individually deployed in the field, it is possible to orient the geographic directions of the azimuth planes of the sensors in a certain way. In the case that the sensors are dropped over the area, the orientation of the azimuth planes is stochastically distributed.

The angular resolution in space associated with the detection at a certain azimuth angle can be limited, for example, by a diaphragm or by an optical lens system. In the case of the hoop array, it is possible to limit the angular resolution in space from the light distribution on the array cells by assuming a point source of radiation that is to be detected. For the operation of the detectors in the further infrared range of, for example, 10 μm, it is possible to cool the photosensitive cells and their radiation shield, for example, thermoelectrically, or by the Peltier effect, or in a bath by means of liquid nitrogen. In the alternative, cooling could occur by gas expansion in accordance with the Joule-Thompson effect.

Within the scope of the detectors, the data can be transmitted via cable, fiberglass, or radio. In the first two cases, it is necessary to distribute, position, and interconnect the detectors each individually in the field. In the latter case, the detectors can simply be dropped from a certain altitude. The detectors may then include directional antennae or arrays of directional antennae, which emit a radio beam only in the horizontal direction, so that possibly no revealing radio beam is emitted into the airspace toward the sky. To this end, the telecommunication units or their radio transmitters can operate with the least transmission power, with the data transportation occurring over short ranges from one detector to a neighboring detector via a so-called hop transportation method. This mode of transmission occurs in accordance with the above-referenced Moteran system.

The processor unit of each detector is in a position to determine from the accumulated data of the detectors the moving time paths of the detected flying objects, to extrapolate the computed moving time paths constantly by mathematics, and to compare them with previously received data or computed and extrapolated moving time paths. This allows the processors to assign to a plurality of different flying objects their own moving time paths, or vice versa to find different flying objects, and to further treat them separately.

The operating mode of the invention proceeds in such a manner that, when a flying object flies over the area with the distributed detectors, certain detectors will successively detect it. In the case of optical detectors, this occurs at a certain angle with a certain angular resolution on the sky. Thus, the detection occurs in the geographic direction of the azimuth plane. In the case of acoustical detectors, the flying object is detected, for example, by means of the directional microphone technique at a certain angle, and in the case of electromagnetic detectors, it is located, for example, by means of directional antennae at a certain angle.

The detector now forwards these measured data via its telecommunication unit to the interface or interfaces of the telecommunication network. Interfaces will automatically result, when an external unit communicates with a certain detector, for example, with the nearest detector. Such an external unit may be, for example, a fire-control unit.

The detectors or those detectors, which is or are used as interface from outside—external unit—signals or signal to the detector network at certain time intervals over and over again that it or they is or are an interface detector or detectors. The detector network, to which replacement detectors or expansion detectors may be added, if need be, at a later time, thus knows its interfaces. The data are passed on by the hop transportation method from detector to detector as far as the interface or interfaces. On the interface or interfaces, the data of all detectors are collected and evaluated. In the detector network, all neighboring detectors monitor the data traffic of their surroundings. Neighboring detectors therefore have always available the same data quantity. In the case that an interface detector malfunctions, each neighboring detector will be able to assume immediately the function of the broken-down interface detector.

However, the collection of the data from all sensors on an interface does not mean that a central data computation occurs on this interface. At this point, only the data are collected, which have already been computed by the individual detectors, and, if necessary, made available to the external unit.

The procedural processing of the data may be performed by the following mathematical method. Each detection of a flying object by a detector furnishes a linear equation with origin. Ultimately, this is the direction in space of the location and the respective detector position. The direction in space can be derived from the geographic orientation of the azimuth plane, from the detected azimuth, and from the position in space, i.e. from the tilting of the detector. When viewed from the detectors, the flying objects are located on locating beams, which extend from the ground. The entirety of the locating beams forms a so-called “Mikado pile,” with all Mikado sticks being inserted with their one end into the ground. The locating beams or locating vectors intersect an area, in which the flight path is located. The flight path points are a subset of such a set of plane points.

The flight path can be computed upon availability of the flight path area equation. The flight path in the flight path area forms a connecting curve, which joins the detectors one after the other in accordance with the sequence of their detection times. Since the detectors and their directions of detection or locating beams, are distributed over the area, for example, in a stochastic manner, this connecting curve is normally a very tangled and strongly folded curve.

Far above the flight path, the intersections of the locating beams form with an imaginary area a strongly folded connecting curve. At the level of the actual flight path area, however, chronologically successive locating beams have in the flight path plane the smallest spacing between one another, and the actual flight path is very likely the flattest curve or the curve with a minimal curvature trend. This in turn can be represented by a polynomial, which is parameterized by the locating time.

To determine an approximated flight path, it is possible to compute the approximate flight path from all available detector data, which consist of locating beam function and locating instant, i.e., the curve with the minimal curvature trend. This curve can be computed, for example, in terms of curvature, as an optimized compensating curve between the end points of the shortest connection distance between respectively two locating vectors with closest locating instants.

If more than one of such extremal curves in the flight path plane are found by this method, several different flying objects will be identified. With the thus-computed, time parameterized flight paths, the movement functions of the located flying objects are available, which can subsequently be extrapolated to be able to predict the flight movement in certain time periods—for example, response time periods. These data can now be forwarded via the interface to externally coupled functional units, such as, for example, reconnaissance units or anti-missile devices in the military sector.

The here-described embodiment of a device for detecting flying objects is a passive and decentralized flight movement reconnaissance and tracking system, which has, for example, in the military sector, the following advantages.

The system is passive and can no longer be recognized by flying objects and be purposefully countered, if need arises. Since the invention comprises, if necessary, many detectors, which are all able to perform the same procedural data acquisition and data processing, and which can all be used individually as a data transmission interface to externally coupled, additional functional units, the invention is very insensitive to failure or destruction of individual detectors. The system remains still operative, even after the failure or destruction of a major portion of the detectors.

Since the invention comprises, if necessary, many detectors of a simplest, technical construction, a mass production can lead to such low manufacturing costs of the individual detectors that the invention is substantially more cost-favorable as regards purchase than central, active, and comparative systems of the art. In the borderline case, the invention could be conceived as a one-time system, in which the sensors are not recovered and reused after their application. This could save substantial costs for logistics, for example, for recovery material and recovery time.

Since the invention in accordance with the embodiment is totally self-controlling and functions automatically, highly specialized and highly qualified operating personnel is saved as is normally needed in the case of a military application. As a result, it is also possible to avoid losses among this operating personnel. This in turn avoids likewise costs of logistics within the scope of, for example, education and training of personnel.

In a simplest manner, the invention can be utilized in the combat field, by simply dropping detectors in a distributed pattern from a certain altitude, for example, from aircrafts. In case the system malfunctions in part or is destroyed, it is possible—if needed—to simply drop additional detectors. Same are able to assume immediately their function in the existing detector network. The detectors of the invention can also be permanently installed as stationary devices in urban areas with highly threatened tactic targets, for example, on street lights, or traffic lights, or other installations with a power supply. In such urban areas, it is possible to use radar systems only to a limited extent because of radiation obstacles by buildings, and in most cases only in an exposed and thus threatened place.

The entirety of all detectors represents, for example, for the military user, a resource, which can be divided and distributed as desired. Comparative, centralized systems of the art are available only in a limited number and can be used only with this functional number. The invention, however, makes it possible to compose from the entirety of the sensors any combinations of large or small systems. It is likewise possible to considerably reduce the number of different systems as are needed by the military. The invention also permits replacing both long-range radar systems and radar systems for detecting low flying objects, or other specialized radar systems.

Finally, it should be explicitly remarked that the above-described embodiment of the device or method in accordance with the invention is used only to explain the claimed teaching, without however limiting it to the embodiment.

1. Device for detecting flying objects in a predeterminable spatial area with a detector responding to the flying object for detecting the flying object, characterized in that at least three detectors are distributed in the way of a network in the spatial area, and that the detectors operate in a passive manner.

2. Device of claim 1, characterized in that the detectors are detectors operating optically, preferably in the infrared range.

3. Device of claim 1 or 2, characterized in that the detectors are acoustically operating detectors.

4. Device of one of claims 1-3, characterized in that the detectors are electromagnetically operating detectors.

5. Device of one of claims 1-4, characterized in that the detectors are designed and constructed for measuring the flying object.

6. Device of one of claims 1-5, characterized in that the detectors are designed and constructed for tracking the flying object.

7. Device of one of claims 1-6, characterized in that the detectors are designed and constructed for computing the flight path of the flying object.

8. Device of one of claims 1-7, characterized in that the data collected by the detectors are processed in a decentralized way.

9. Device of one of claims 1-8, characterized in that a processor for processing data is allocated to each detector.

10. Device of one of claims 1-9, characterized in that a position finding and/or locating unit is allocated to each detector.

11. Device of one of claims 1-10, characterized in that a telecommunication unit for transmitting data is allocated to each detector.

12. Device of one of claims 1-11, characterized in that the data transmission can be carried out via radio signals and/or optical and/or acoustical signals.

13. Device of one of claims 1-12, characterized in that the data transmission can be carried out via electric cables and/or fiberglass cables.

14. Device of one of claims 1-13, characterized in that an energy supply unit is allocated to each detector.

15. Device of one of claims 1-14, characterized in that the detectors are each arranged in a spherical housing.

16. Device of one of claims 1-15, characterized in that the detectors are allocated to the earth's surface.

17. Device of one of claims 1-16, characterized in that the detectors can be stochastically distributed over the earth's surface, preferably by dropping or deploying them from an aircraft.

18. Device of one of claims 1-17, characterized in that the detectors comprise each a device for braking a free fall.

19. Device of claim 18, characterized in that the device has a position stabilizing effect.

20. Device of one of claims 1-19, characterized in that a diaphragm rotating about a sensor or an annular linear sensor arrangement or a planar or spherical sensor arrangement is allocated to each detector.

21. Device of one of claims 1-20, characterized in that the sensor or sensors or a radiation shielding of the sensor or sensors are thermoelectrically cooled, cooled by the Peltier effect, or cooled in a bath by means of liquid nitrogen, or cooled by gas expansion via the Joule-Thompson effect.

22. Method for detecting flying objects in a predeterminable spatial area, in particular for operating a device of one of claims 1-21, with a detector responding to the flying object for detecting the flying object, characterized in that at least three detectors coupled in the way of a network are distributed over the spatial area, and that the detectors operate in a passive manner.

23. Method of claim 22, characterized in that the data collected by the detectors are processed in a decentralized manner.

24. Method of claim 22 or 23, characterized in that a processor for processing data is allocated to each detector.

25. Method of claim 24, characterized in that the processor of each detector determines and preferably constantly extrapolates from the accumulated data of the detectors, the time-dependent paths of movement of the detected flying object or objects.
